(19) United States
(12) Patent Application Publication
(10) Pub. No.: US 2008/0002734 A1
(43) Pub. Date: Jan. 3, 2008

(54) Contention window management for relay networks

(76) Inventors: Haihong Zheng, Coppell, TX (US); Yousuf Saifullah, Richardson, TX (US); Khiem Le, Coppell, TX (US); Yogesh Swami, Irving, TX (US)

Correspondence Address: BRAKE HUGHES BELLERMANN LLP, c/o INTELLEVATE, P.O. BOX 52050, MINNEAPOLIS, MN, 55402, US

(21) Appl. No.: 11/478,349

(22) Filed: Jun. 29, 2006

(51) Int. Cl. H04L 12/413

(52) U.S. Cl. 370/445

(57) ABSTRACT

Various example embodiments are disclosed relating to contention window management in relay networks. In an example embodiment, a data unit transmitted from a network node based on a first contention window associated with a first network station may be received, for example, by the first network station located, for example, on a first level. The data unit may be forwarded to a second network station based on a second contention window associated with the second network station. The second network station may, for example, be located on a second level. The first network station may, for example, include a relay station and the second network station may, for example, include a base station.

### BACKGROUND

The rapid diffusion of Wireless Local Area Network (WLAN) access and the increasing demand for WLAN coverage is driving the installation of a very large number of Access Points (AP). The most common WLAN technology is described in the Institute of Electrical and Electronics Engineers IEEE 802.11 family of industry specifications, such as specifications for IEEE 802.11b, IEEE 802.11g and IEEE 802.11a. Other wireless technologies are being developed, such as IEEE 802.16 or WiMAX technology. A number of different 802.11 task groups are involved in developing specifications relating to improvements to the existing 802.11 technology. For example, a draft specification from the IEEE 802.11e Task Group has proposed a set of QoS parameters to be used for traffic between an Access Point and a station. See, e.g., Tim Godfrey, “Inside 802.11e: Making QoS A Reality Over WLAN Connections,” CommsDesign, Dec. 19, 2003. Similarly in Ultra Wideband (UWB) environment, the WiMedia Alliance has published a draft standard, “Distributed Medium Access Control (MAC) for Wireless Networks,” Release 1.0, Dec. 8, 2005.

As another example, a wireless relay network may include a multi-hop system in which end nodes such as mobile stations or subscriber stations (MS/SSs) may be coupled to a base station (BS) or Access Point (AP) via one or more relay stations (RSs). Thus, traffic between MS/SSs and the BS/AP may pass and be processed by the relay stations. The 802.16 Mobile Multi-hop Relay (MMR), referenced in IEEE 802.16 WG, is an example of a set of specifications relating to the relay concept. The MMR specifications include a focus on defining a network system that uses relay stations (RSs) to extend network coverage and/or enhance system throughput. These are a few examples of wireless network specifications, and there are many other technologies and standards being developed.

In the context of wireless network systems without relay stations, a number of wireless standards allow stations to access a channel through a contention based channel access mechanism, where wireless nodes may contend for channel access. For example, in WiMedia Distributed MAC specification, this channel access technique is referred to as prioritized contention access (PCA), where contention access is provided using different access categories (ACs), or traffic priorities. For example, for WiMedia and for 802.11e Enhanced Data Channel Access (EDCA), different quality of service (QoS) parameters may be provided for each AC.

As yet another example, in 802.16 WirelessMAN specification, a base station, for example, may poll end nodes by allocating to end nodes bandwidth specifically for the purpose of making requests, for example, bandwidth requests. Such allocations may, for example, be sent to the end nodes as a series of uplink intervals including contention transmission opportunities. The end nodes may then contend for these transmission opportunities, for example, for sending requests, for example, for bandwidth, to the base station.

### SUMMARY

Various embodiments are disclosed relating to wireless networks, and also relating to contention window management in a relay network.

According to one example embodiment, a method may be provided that includes receiving a data unit transmitted from a network node based on a first contention window associated with a first network station. The method may further include forwarding the data unit to a second network station based on a second contention window associated with the second network station.

As an example embodiment, one of the first and second network stations may include a relay station. As another example embodiment, the receiving the data unit may include receiving the data unit transmitted from a network node based on a first contention window associated with a relay station located at a first level, and the forwarding the data unit may include forwarding the data unit to a base station based on the second contention window associated with the base station located at a second level.

As another example embodiment, the forwarding the data unit may include forwarding the data unit to a base station based on the second contention window associated with the base station located at a second level.

As another example embodiment, the forwarding the data unit may include forwarding the data unit to the second network station based on a portion of the second contention window that is dedicated to data units that have been transmitted based on the first contention window.

According to another example embodiment, an apparatus may be provided in a wireless network. The apparatus may be adapted to receive a data unit transmitted from a network node based on a first contention window associated with a first network station. The apparatus may be further adapted to forward the data unit to a second network station based on a second contention window associated with the second network station.

According to another example embodiment, an apparatus may include a base station, one or more stations at a first level, and one or more stations at a second level that are coupled to the base station. The one or more stations at the first level may be coupled to one of the one or more stations at the second level, the one or more of the stations at the first level using a first contention window size. The one or more stations at the second level may use a second contention window size.

According to another example embodiment, an article may include a storage medium. The storage medium may include stored thereon instructions that, when executed by a processor, result in receiving a data unit transmitted from a network node based on a first contention window associated with a first network station; and forwarding the data unit to a second network station based on a second contention window associated with the second network station.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating a wireless network according to an example embodiment.

FIG. 2 is a block diagram illustrating a wireless network according to an example embodiment.

FIG. 3a is a block diagram illustrating a wireless relay network according to an example embodiment.

FIG. 3b is a diagram of a multi-hop environment according to an example embodiment.

FIGS. 4a-4b are block diagrams illustrating wireless relay networks according to example embodiments.

FIG. 5a is a block diagram illustrating an example contention window according to an example embodiment.

FIG. 5b is a timing diagram illustrating operation of a wireless node according to an example embodiment.

FIG. 6 is a flow chart illustrating operation of a wireless node according to an example embodiment.

FIG. 7 is a block diagram illustrating an apparatus that may be provided in a wireless node according to an example embodiment.

### DETAILED DESCRIPTION

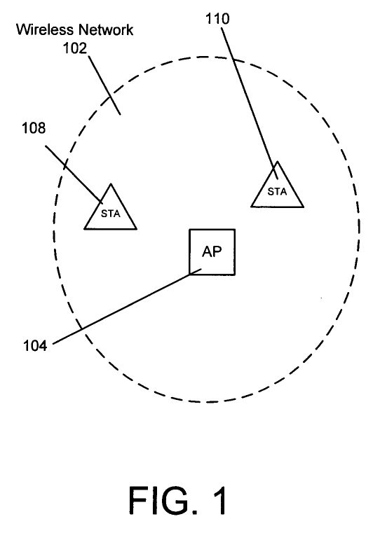

Referring to the Figures in which like numerals indicate like elements, FIG. 1 is a block diagram illustrating a wireless network 102 according to an example embodiment. Wireless network 102 may include a number of wireless nodes or stations, such as an access point (AP) 104 or base station and one or more mobile stations or subscriber stations, such as stations 108 and 110. While only one AP and two mobile stations are shown in wireless network 102, any number of APs and stations may be provided. Each station in network 102 (e.g., stations 108, 110) may be in wireless communication with the AP 104, and may even be in direct communication with each other. Although not shown, AP 104 may be coupled to a fixed network, such as a Local Area Network (LAN), Wide Area Network (WAN), the Internet, etc., and may also be coupled to other wireless networks.

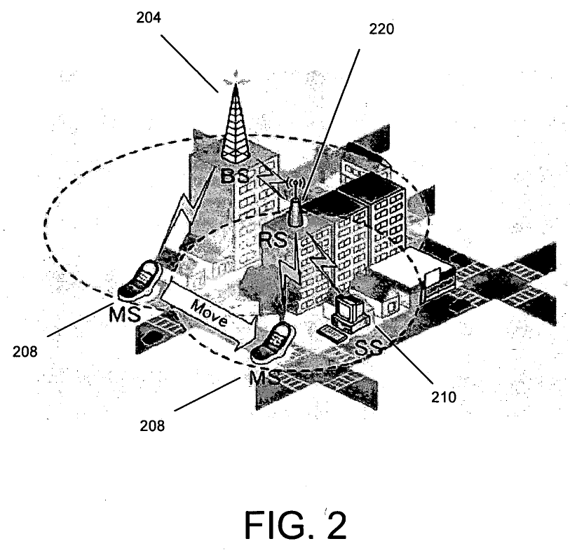

FIG. 2 is a block diagram illustrating a wireless network according to an example embodiment. According to an example embodiment, a mobile station MS 208 may initially communicate directly with a base station BS 204, for example, and a subscriber station 210 may communicate with the base station BS 204 via a relay station RS 220. In an example embodiment, the mobile station 208 may travel or move with respect to base station BS 204. For example, the mobile station MS 208 may move out of range of the base station BS 204, and may thus begin communicating with the base station 204 via the relay station 220 as shown in FIG. 2.

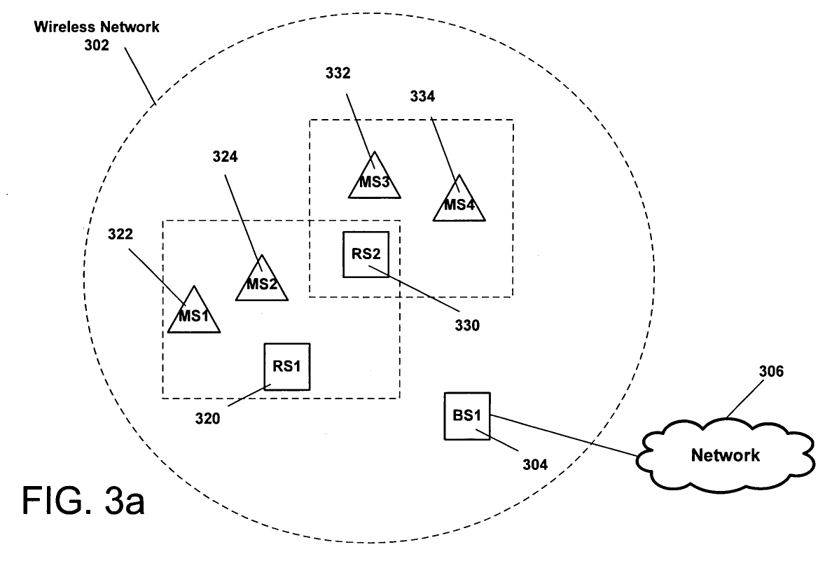

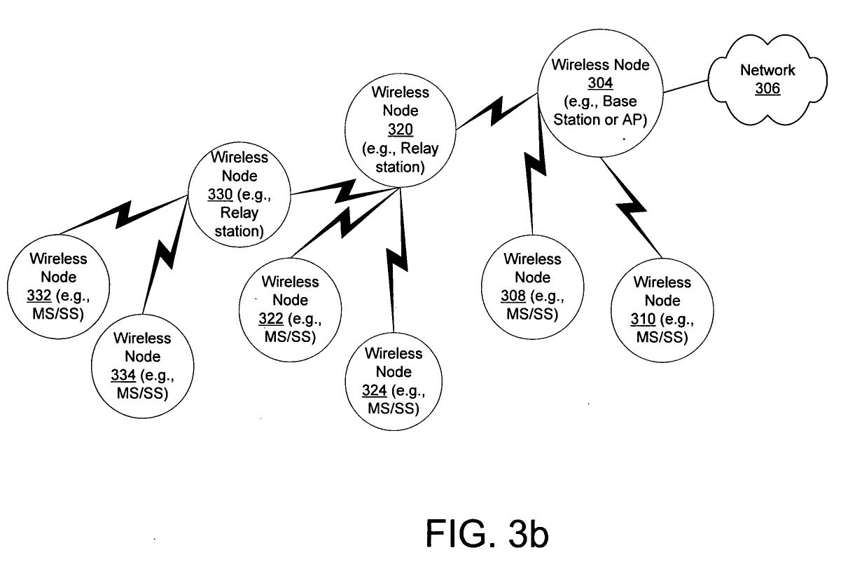

FIG. 3a is a block diagram illustrating a wireless network 302 according to an example embodiment. Wireless network 302 may include a number of wireless nodes or stations, such as base station BS1 304, relay stations RS1 320 and RS2 330, a group of mobile stations, such as MS1 322 and MS2 324 communicating with relay station RS1 320, and MS3 332 and MS4 334 communicating with relay station RS2 330. As shown, relay station RS2 330 also communicates with relay station RS1 320. While only one base station, two relay stations, and four mobile stations are shown in wireless network 302, any number of base stations, relay stations, and mobile stations may be provided. The base station 304 may be coupled to a fixed network 306, such as a Wide Area Network (WAN), the Internet, etc., and may also be coupled to other wireless networks. The group of stations MS1 322, MS2 324, and RS2 330 may communicate with the base station BS1 304 via the relay station RS1 320. The group of stations MS3 332, MS4 334, may communicate with the base station BS1 304 via the relay station RS2 330, which communicates with the base station BS1 304 via the relay station RS1 320.

FIG. 3b is a diagram of a multi-hop environment according to an example embodiment. A group of wireless nodes 332, 334, which may be mobile stations or subscriber stations (MS/SS) may each be coupled via a wireless link to a wireless node 330. As an example, the wireless nodes 332, 334 may include mobile telephones, wireless digital assistants (PDAs), or other types of wireless access devices, or mobile stations. The term “node” may refer, for example, to a wireless station, e.g., a subscriber station or mobile station, an access point or base station, a relay station or other intermediate wireless node, or other wireless computing device, as examples. Wireless node 330 may include, for example, a relay station or other node. Wireless node 330 and other wireless nodes 322, 324 may each be coupled to a wireless node 320 via a wireless link. Wireless node 320 and other wireless nodes 308, 310 may each may be coupled to a wireless node 304 via a wireless link. Wireless node 304 may be, for example, a base station (BS), access point (AP) or other wireless node. Wireless node 304 may be coupled to a fixed network, such as network 306, for example. Frames or data flowing from nodes 332, 334 to 330, 322 324, and 330 to 320, and 308, 310,320 to node 304 may be referred to as flowing in the uplink (UL) or upstream direction, whereas frames flowing from node 304 to nodes 308, 310, and to node 320 and then to nodes 330, 322, 324, 332, and 334 may be referred to as flowing in the downlink (DL) or downstream direction, for example.

The various example embodiments described herein may be applicable, for example, to a wide variety of networks and technologies, such as WLAN networks (e.g., IEEE 802.11 type networks), IEEE 802.16 WiMAX networks, 802.16 Mobile Multi-hop Relay (MMR) networks, as referenced in IEEE 802.16 WG, WiMedia networks, Ultra Wide Band networks, cellular networks, radio networks, or other wireless networks. In another example embodiment, the various examples and embodiments may be applied, for example, to a mesh wireless network, where a plurality of mesh points (e.g., Access Points) may be coupled together via wired or wireless links. The various example embodiments described herein may be applied to wireless networks, both in an infrastructure mode where an AP or base station may communicate with a station (e.g., communication occurs through APs), as well as an ad-hoc mode in which wireless stations may communicate directly via a peer-to-peer network, for example. These are merely examples, and it is to be understood that the techniques described may apply to any type of network environment.

A wireless relay network may be an example of a multi-hop system in which end nodes, for example, mobile stations or subscriber stations, may be connected to a base station via one or more relay stations, such as RS1 320 and RS2 330, for example. Traffic between the mobile statioris or subscriber stations and the base station may pass through, and be processed by, the relay stations RS1 320 and RS2 330, for example. As an example, a relay station may be used to extend the network coverage and/or enhance the system throughput. For example, the traffic sent from a relay station may be scheduled by the relay station itself or scheduled by the base station instead. In some cases, a relay station may receive and decode a frame from a base station, and then forward the frame to the respective mobile station or subscriber station.

The term “wireless node” or “network station” or “node,” or the like, may include, for example, a wireless station, such as a mobile station or subscriber station, an access point (AP) or base station, a relay station, a wireless personal digital assistant (PDA), a cell phone, an 802.11 WLAN phone, a WiMedia device, a WiMAX device, a wireless mesh point, or any other wireless device. These are merely a few examples of the wireless devices and technologies that may be used to implement the various example embodiments described herein, and this disclosure is not limited thereto.

In an example wireless network system without RSs, a wireless node, for example, a base station or access point (BS/AP) may assign a contention window including a value indicating one or more transmission opportunities for the uplink traffic. End nodes, for example, the MS/SSs may then contend for these transmission opportunities. If a collision is detected, e.g., more than one MS/SS sends traffic in the same transmission opportunity, the MS/SS may apply a contention resolution technique such as, e.g., binary exponential backoff, and may retransmit, for example, after a backoff counter reaches a predetermined value or after a backoff time expires.

For example, a base station may control assignments on an uplink contention window through parameters sent to the end nodes, for example, via uplink map (UL-MAP) messages, for example, according to 802.16 UL-MAP messages. The base station, for example, may then determine which transmission opportunities are subject to collisions. The contention window size may be dynamically changed on a frame by frame basis. When a wireless node such as an end node, e.g., MS/SS has information to send and wants to enter the contention resolution process, the end node may set its internal backoff window to a value, for example, a value defined by the BS, for example, a Request Backoff Start sent by the BS via an uplink channel description message, for example, via an 802.16 UCD message. The wireless node may then randomly select a number within its backoff window. The random number may indicate, for example, a number of transmission opportunities that the wireless node may defer before transmitting.

After a contention transmission, the wireless node, e.g., MS/SS may wait for a resource grant from the BS, for example, a resource grant indicated by a subsequent UL-MAP message. Once a resource grant is received, the contention resolution may be considered complete. The wireless node, e.g., MS/SS may thus consider the contention transmission lost if no resource grant has been received within a predetermined interval, e.g., a predetermined time period. In this case, according to one aspect, the wireless node, e.g., MS/SS may then increase its backoff window size by a factor of two. The wireless node, e.g., MS/SS may then randomly select a number within its new backoff window and repeat the deferring process described above.

Another level of contention may be introduced by the addition of one or more relay stations into the wireless network. An example goal of managing multiple levels of contentions may include providing equal transmission opportunities to all the MS/SSs in the system while maintaining a low system overhead.

According to an example embodiment, if each BS and RS in a wireless network is associated with its own contention window, a size of each contention window and a mapping between different levels of contention windows may be determined to provide equal opportunities to all the MS/SSs to contend for resources without regard to whether a particular MS/SS is attached to a BS or a RS, while maintaining a reasonable system overhead.

Various techniques may thus be provided for allocating multi-level contention windows (CWs) in relay networks. According to one example aspect, a wireless node, e.g., a BS may allocate different levels of CWs based on system parameters which may include various factors such as, for example, a number of users attached, a traffic load condition, and a collision history. One example goal of such techniques may include providing sufficient fairness on transmission opportunities to all the MS/SSs in the system without regard to whether it is coupled to the base station or to any one of different levels of relay stations (RSs), while at the same time maintaining reasonable system overhead. Thus, according to one example aspect, the non-collided requests at each level of the CWs may contend again with other requests in a higher level of the CWs.

According to another example aspect, the non-collided requests at each level of the CWs may contend again with other requests in a dedicated portion of a CW in a higher level that may be reserved for the non-collided requests from a CW in a lower level. Examples of these techniques are described further below.

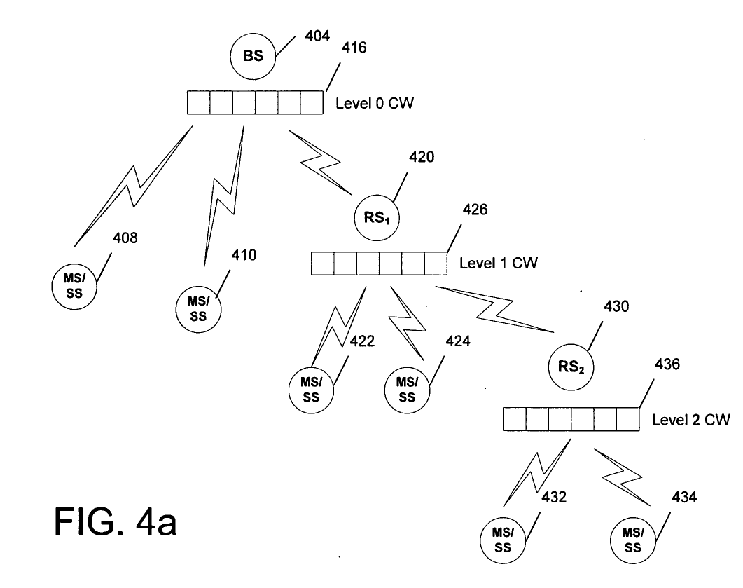

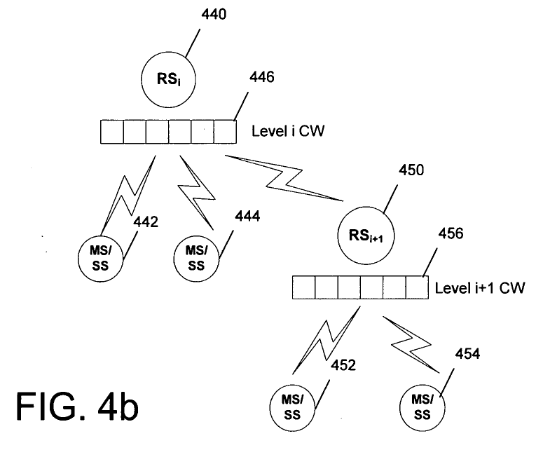

FIGS. 4a-4b are block diagrams illustrating wireless relay networks according to example embodiments. According to an example embodiment, if an example relay network has n levels of RSs, then each BS and RS in the system may be associated with its own contention window. As an example, a two-level-relay-station architecture is illustrated in FIG. 4a. As shown in the example, a level 0 contention window (CW) 416 may be used by all MS/SSs and RSs coupled to, or directly attached to, a base station BS 404. Thus, as shown in the example, MS/SS 408, MS/SS 410, and RS1 420 may use the level 0 contention window (CW) 416 associated with the base station BS 404 to contend for transmission opportunities to transmit to BS 404.

For example, the CW 416 may be considered to include multiple transmission opportunities that may be desired by one or more of the MS/SSs and/or RSs in the relay network, and thus the MS/SSs and/or RSs that desire one or more transmission opportunities may contend for them.

Similarly, a level 1 CW 426 may be used by all MS/SSs and RSs coupled to, or directly attached to the RS1 420. Thus, as shown in the example, MS/S S 422, MS/SS 424, and RS2 430 may use the level 1 contention window (CW) 426 associated with the relay station RS1 420 to contend for transmission opportunities to transmit to the RS1 420.

Similarly, a level 2 CW 436 may be used by all MS/SSs and RSs coupled to, or directly attached to the RS2 430. Thus, as shown in the example, MS/SS 432 and MS/SS 434 may use the level 2 contention window (CW) 436 associated with the relay station RS2 430 to contend for transmission opportunities to transmit to the RS2 430.

An example generic view of multiple levels of CWs is shown in FIG. 4b. As shown in the example, a level i contention window (CW) 446 may be used by all MS/SSs and RSs coupled to, or directly attached to, a network node, e.g., a relay station RSᵢ 440. Thus, as shown in the example, MS/SS 442, MS/SS 444, and RSᵢ₊₁ 450 may use the level i contention window (CW) 446 associated with the relay station RSᵢ 440 to contend for transmission opportunities to transmit to RSᵢ 440. Similarly, MS/SSs (e.g., MS/SS 452, 454) and RSs coupled to, or directly attached to RSᵢ₊₁ 450 may contend with each other using a level i+1 CW 456. For the generic example as shown, a wireless node indicated as RS₀ may include a base station.

According to one example aspect, the various wireless nodes may contend among themselves for the transmission opportunities included in the CWs using contention and contention resolution mechanisms as described below.

As an example, for traffic that has been transmitted without collision in a particular transmission opportunity in a level i+1 CW 456 (i.e., only one MS/SS attached to RSᵢ₊₁ 450 has sent traffic on that transmission opportunity), RSᵢ₊₁ 450 may select a transmission opportunity in the level i CW 446 and forward the non-collided traffic to the RS 440 in the selected transmission opportunity. The forwarded traffic may then be subject to collision with the traffic sent from other MS/SSs or RSs attached to the RSᵢ 440. According to one example aspect, if particular traffic collides in a particular transmission opportunity in the level i+1 CW 456, i.e., more than one MS/SS attached to RSᵢ₊₁ 450 sends traffic on the same transmission opportunity, the RSᵢ₊₁ may drop the traffic without forwarding the collided traffic to the RSᵢ 440. At some point, an originating MS/SS may determine that its transmitted traffic may not have been received by the intended destination BS, and the originating MS/SS may then retransmit the traffic. According to another aspect, RSᵢ₊₁ may determine that its transmitted traffic may not have been received by RSᵢ or the intended destination BS since for example it hasn't received the bandwidth grant for the associated MS/SS after certain time period, and may then retransmit the traffic.

According to one example aspect, in order to allow more than one MS/SS attached to a wireless node such as RSᵢ₊₁ 450 to be able to send traffic successfully to RSᵢ 440, RSᵢ₊₁ 450 may be configured to send traffic on multiple transmission opportunities in the level i CW 446. The traffic may have been transmitted to RSᵢ₊₁ 450 from different MS/SSs coupled to or attached to RSᵢ₊₁, e.g., from MS/SS 452 and MS/SS 454. Alternatively, the traffic may have been transmitted to RSᵢ₊₁ 450 from a single MS/SS, for example, from MS/SS 452 or MS/SS 454.

Similarly, according to another example aspect, if the RSᵢ 440 attaches to a wireless node RSᵢ₋₁ (not shown) which is not a base station or access point, then similar techniques as discussed above with regard to RSᵢ₊₁ 450 may be applied to the RSᵢ 440.

According to an example embodiment, an example technique of mapping successful (i.e., non-collided) traffic from a level i+1 CW 456 to a level i CW 446 may include, for example, a common, or shared, contention pool. For example, the wireless node RSᵢ 440 may not reserve a specific portion of its associated level i CW 446 for non-collided traffic from RSᵢ₊₁ 450. Thus, all non-collided traffic to be forwarded from RSᵢ₊₁ 450 that has been received by RSᵢ₊₁ 450 through level i+1 contention may contend again with other MS/SSs and RSs coupled to, or attached to RSᵢ 440.

According to one example aspect, a size of the level i+1 CW 456 may be the same, or substantially the same, as a size of the level i CW 446. Thus, non-collided traffic to be forwarded from RSᵢ₊₁ 450 through level i+1 CW 456 may be forwarded to RS 440 on the same, or substantially the same, transmission opportunity, in the level i CW 446. The traffic forwarded according to this technique may be subjected to collision at the level i CW 446.

According to another example aspect, a size of the level i+1 CW 456 may be different, or substantially different, from a size of the level i CW 446. Thus, for example, a base station may determine a size of each contention window CW (e.g., level i CW 446, level i+1 CW 456, etc.) on a frame by frame basis based on one or more system parameters. For example, the size of each contention window may be based on one or more of a number of users, a traffic load under each wireless node, e.g., each RS, and/or a collision history on the uplink. Since the size of two CWs may be different from each other, a mapping scheme to map the non-collided traffic, for example, from RSᵢ₊₁ 450 to the transmission opportunities in the level i CW 446 associated with RSᵢ 440 may be determined. To reduce potential collisions, it may be determined, for example, that RSᵢ₊₁ 450 may not map two units of non-collided traffic into the same or substantially the same transmission opportunities in the level i CW 446. As an example, a base station may determine a larger CW size for a CW associated with the base station than a size of a CW associated with a relay station coupled to the base station, as the base station may potentially serve more users than the relay station.

According to another example embodiment, another example technique of mapping successful (i.e., non-collided) traffic from a level i+1 CW 456 to a level i CW 446 may include, for example, a dedicated portion of a contention window. Thus, for example, a wireless node, for example, RSᵢ 440 may reserve a portion of the level i CW 446 (i.e., k transmission opportunities) for all the traffic to be sent to RSᵢ 440 from RSᵢ₊₁ 450. Thus, for example, a base station may determine a value of k on a frame by frame basis based on one or more system parameters. For example, the value of k may be based on system conditions such as a number of users, a traffic load under each wireless node, e.g., each RS, and/or a collision history on the uplink.

As an example, in order to avoid collision in the dedicated part of the level i CW 446, which may lead to a waste of resources, the wireless node, e.g., RSᵢ₊₁ 450 may select k units of traffic, or k data units, among the non-collided traffic received by RSᵢ₊₁ 450 based on the level i+1 CW 456 and may map the selected units to the dedicated k transmission opportunities in the level i CW 446 if a number of non-collided traffic units or data units from the level i+1 CW 456 is larger than k. Therefore, no contention may be applied to the traffic that may be forwarded from the RSᵢ₊₁ 450 to the RSᵢ 440.

According to an example embodiment, one or more relay stations, for example, RSᵢ 440, RSᵢ₊₁ 450 may receive data units and forward the data units to the next level of the wireless relay network based on the level i and level i+1 contention windows without backoff. Thus, the RSᵢ 440 and RSᵢ₊₁ 450 may merely receive and forward data units using the CWs, but without performing backoff techniques.

According to another example embodiment, one or more relay stations, for example, RSᵢ 440, RSᵢ₊₁ 450 may receive data units and forward the data units to the next level of the wireless relay network based on the level i and level i+1 contention windows with backoff, for example, when a collision is determined. Thus, the RSᵢ 440 and RSᵢ₊₁ 450 may receive and forward data units using the CWs, and may perform backoff techniques when collisions are determined.

An example contention resolution technique may be based on a truncated binary exponential backoff, with an initial backoff window and a maximum backoff window controlled, for example, by the BS, e.g., the BS 404 or any other wireless node. For example, these minimum and maximum values may be specified as part of a channel description, for example, as part of an uplink channel description (UCD) message (e.g., an 802.16 UCD message) that may be sent by the base station, e.g., BS 404. For example, the windows may be represented as power-of-two values. For example, a backoff window value of 4 may indicate a backoff window between 0 and 15; a value of 10 may indicate a backoff window between 0 and 1023.

For example, when a wireless node, e.g., a MS/SS or RS, has information to send and wants to enter the contention resolution process, it may set a backoff window (internal to the wireless node) equal to the initial window value as discussed previously. For example, an initial value may include a Request (or Ranging for initial ranging) Backoff Start value that may be indicated, for example, in a UCD message referenced by a UCD Count in a UL-MAP message that is currently in effect.

The wireless node that wants to enter contention may then randomly select a number within its backoff window. This random value may indicate a number of transmission opportunities or contention transmission opportunities that the wireless node may defer before transmitting. In deferring, the wireless node may consider only transmission opportunities for which this transmission would have been eligible. Such eligible transmission opportunities may be indicated, for example, by contention windows or uplink intervals indicated via Request Information Elements (IEs) or Initial Ranging IEs that may be sent, for example, by a base station via UL-MAP messages (e.g., 802.16 UL-MAP messages). For example, each IE may indicate multiple transmission opportunities or contention transmission opportunities.

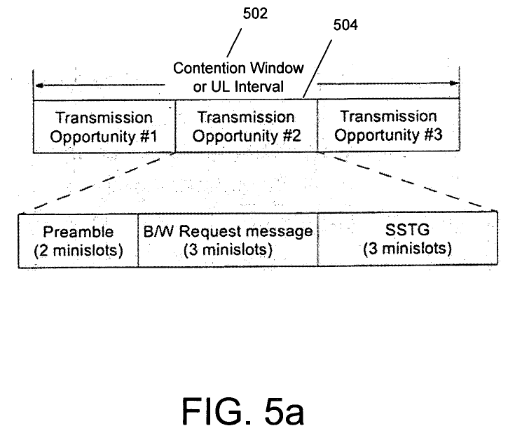

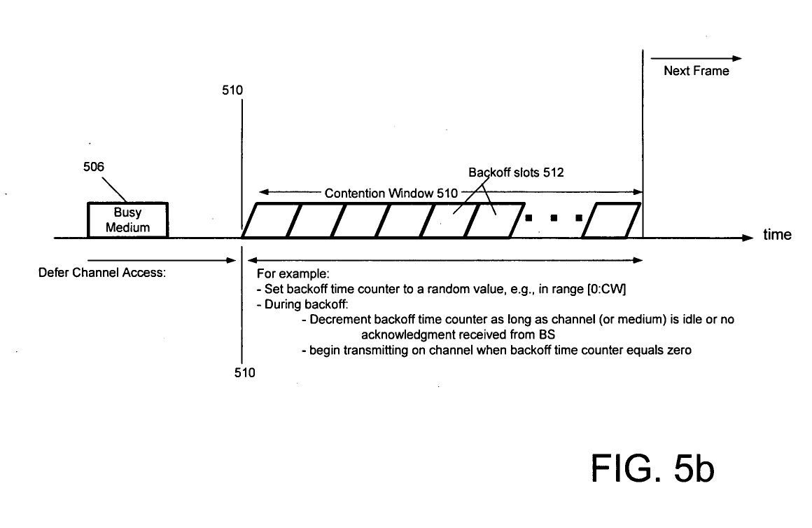

FIG. 5a is a block diagram illustrating an example contention window or uplink interval 502 according to an example embodiment. As shown in the example of FIG. 5a, the contention window or uplink interval 502 may, for example, be indicated via an information element (IE) sent by a base station, e.g., BS 404, to a network node, e.g., MS/SS 422 or RS2 430. As shown in the example of FIG. 5a, the BS 404 may indicate a contention window or uplink interval in which requests may be made for resources, e.g., bandwidth, for uplink transmission, e.g., for uplink data transmission. As shown in FIG. 5a, the example contention window or uplink interval 502 may indicate three example transmission opportunities. An example transmission opportunity #2 (504) may indicate a preamble that may be indicated as occupying 2 minislots, or units of allocated transmission resources (e.g., a unit of uplink bandwidth allocation), a bandwidth request message that may be indicated as occupying 3 minislots, and a subscriber station transition gap (SSTG) that may be indicated as occupying 3 minislots.

In the context of contention transmission opportunities indicated by such a contention window or uplink interval 502, the term “transmission opportunity” may refer to an allocation provided to network nodes that may be permitted to request one or more resources (e.g., bandwidth) for transmission. For example, a base station, e.g., BS 404, or other network node, may provide indicators of transmission opportunities (e.g., via the contention window or uplink interval 502) via an uplink map (e.g., an 802.16 UL-MAP) which may be provided to one or more network nodes, e.g., MS/SSs and/or RSs that may be permitted to send, for example, bandwidth requests or initial ranging requests.

For example, a MS/SS may have data to send to a BS, and may thus desire transmission resources such as bandwidth for transmitting the data to the BS. The MS/SS may have received information regarding its initial backoff window via a UCD message from the base station. Assuming, for example, that the initial backoff window is 0 to 15, the MS/SS may then select a random number in the range 0 to 15, for example, the MS/SS may randomly select the number 11. The SS/MS may then defer a total of 11 transmission opportunities or contention transmission opportunities before transmitting the desired data. As an example, if a first available contention window or uplink interval indicated by a Request IE (e.g., sent by the BS via a UL-MAP) indicates 6 transmission opportunities, the MS/SS may not use any of these 6 and thus may defer for 5 more transmission opportunities. If a next contention window or uplink interval indicated by a Request IE (e.g., sent by the BS via a second UL-MAP) indicates 2 transmission opportunities, the MS/SS may not use any of these 2 and thus may defer for 3 more transmission opportunities. If a third contention window or uplink interval indicated by a Request IE indicates 8 transmission opportunities, the MS/SS may transmit on the fourth transmission opportunity, after deferring for 3 more transmission opportunities.

For example, after a contention transmission, the MS/SS may determine whether a collision occurred in the transmission, for example, by waiting for a Data Grant Burst Type IE to be indicated by a subsequent UL-MAP map, or by waiting for a ranging response message (e.g., a RNG-RSP message) for initial ranging. If such a message is received the contention resolution may be considered complete.

However, the example MS/SS may consider the contention transmission lost if no indicator of a data grant, or no ranging response, has been received within a predetermined waiting period, for example, within receipt of a predetermined number of UL-MAPs. The example MS/SS may then increase its backoff window, for example, by a factor of two, as long as the increased backoff window is smaller than the maximum backoff window. The example MS/SS may then randomly select a number within its new backoff window and repeat the deferring process as discussed above.

For bandwidth requests, if the example MS/SS receives a unicast Request IE or Data Grant Burst Type IE at any time while deferring for a particular node identifier, it may stop the contention resolution process and may use an explicit transmission opportunity indicated by the received unicast IE.

According to another example embodiment in which a wireless node may sense a medium, the wireless node may, for example, start a backoff time counter associated with the wireless node after detecting an idle channel for at least a predetermined interval value, or, for example, after waiting a predetermined interval for a response from a base station acknowledging a request from the wireless node to send data.

FIG. 5b is a timing diagram illustrating operation of a wireless node according to an example embodiment. According to an example embodiment, a wireless node may delay its transmission by the length of its backoff time counter to allow other nodes to win or obtain transmission opportunities. In FIG. 5b, an example contention window 510 is shown, and may include one or more backoff slots 512.

Thus, for example, in a wireless network system without RSs, the BS/AP may assign a contention window containing multiple slots, each of which may represent one transmission opportunity for the uplink traffic. The MS/SS may contend among these transmission opportunities. If a collision is detected (i.e., more than one MS/SS sends traffic in the same transmission opportunities), the MS/SS may apply a contention resolution method (e.g., binary exponential backoff) and retransmit after backoff time expires.

Thus, for example, when an example MS/SS has information to send and wants to enter a contention resolution process, it may set its internal backoff window or contention window to a Request Backoff Start, for example, defined by the BS, and then randomly select a number within its backoff window. The random number may indicate the number of transmission opportunities that the MS/SS may defer before transmitting. After a contention transmission, the MS/SS may determine whether a collision occurred in its transmission by waiting for a resource grant from the BS in a subsequent UL-MAP message. Once such a resource grant is received, the contention resolution may be considered complete. The MS/SS may consider the contention transmission lost if no data grant has been given within a predetermined time period. If it is determined that a collision occurred, the MS/SS may then increase its backoff window by a factor of two. The MS/SS may then randomly select a number within its new backoff window and repeat the deferring process described above.

According to another example, a wireless node with a packet to transmit may monitor the channel (e.g., the medium) to determine when it may be permissible to transmit data. Initially, for example, the channel may be busy at 506. However, the channel may become idle. If the channel is idle for a period of time, the wireless node may generate a backoff time to decrease the probability of collision. The backoff time may be selected, for example, as a random value in the range [0, CW], where CW indicates the contention window size. The backoff time may be an integer indicating a number of backoff slots, for example.

According to an example, CW may initially be set to CWmin or a minimum contention window size. Thus, depending on the CWmin, the backoff time may be set to zero, or some other value, for example. The backoff time counter may be set to this backoff time. According to this example embodiment, the contention window and random backoff time counter may use a discrete scale, measured in backoff slots, for example. If an attempt to access a channel is unsuccessful due to collisions, then the wireless node may increase the CW (e.g., up to CWmax), select a new random backoff time between [0, CW] for the backoff time counter, and then may re-attempt to access the channel. This process may be repeated, with CW increasing after each collision or unsuccessful attempt, for example.

According to an example, during this random backoff, a random backoff time counter may be decremented so long as the channel is sensed idle, may be frozen when a transmission is detected on the channel, and may be restarted or may continue decrementing when the channel is again sensed idle for a predetermined period. The wireless node may then transmit over the channel when its backoff time counter reaches zero, for example. A node may transmit at the beginning of a backoff slot. The contention window, CW, may be set to zero or some other value, as noted.

As noted above, nodes may increase a backoff window size after each collision or unsuccessful attempt to access a channel, for example.

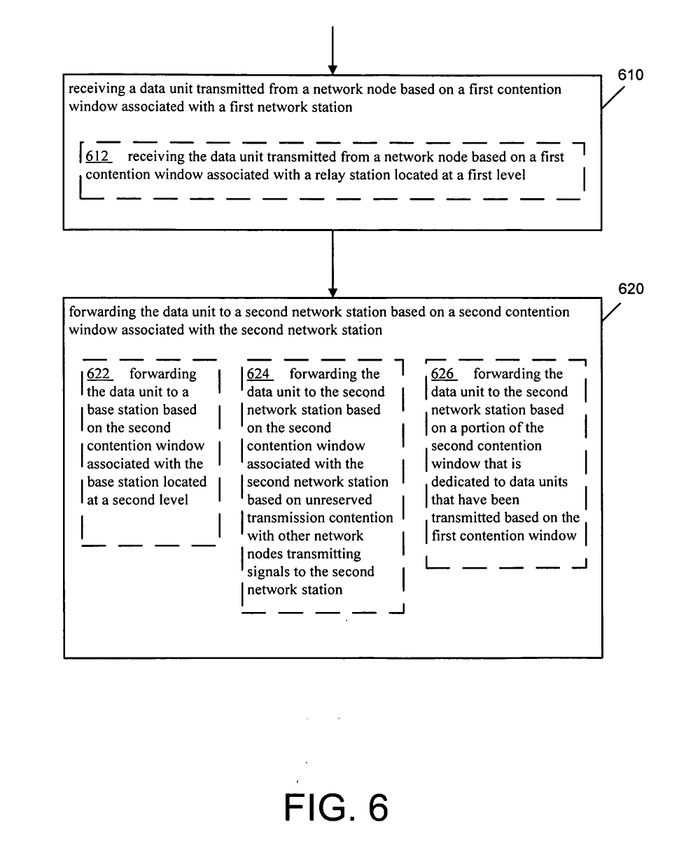

FIG. 6 is a flow chart illustrating operation of a wireless node according to an example embodiment. At 610, a data unit transmitted from a network node based on a first contention window associated with a first network station may be received. Operation 610, for example, may include the data unit being received by a relay station such as, for example, the relay station RS1 420.

As another example of operation 610, a data unit transmitted from a network node based on a first contention window associated with a relay station located at a first level may be received (612). For example, the RS1 420 may receive a data unit transmitted from the RS2 430 that was transmitted based on the level 1 CW 426 associated with the RS1 420.

At 620, the data unit may be forwarded to a second network station based on a second contention window associated with the second network station. For example, operation 620 may include forwarding the data unit to a base station based on the second contention window associated with the base station located at a second level (622). For example, the RS1 420 may forward the received data unit to the BS 404 based on the level 0 CW 416 associated with the BS 404.

As another example of operation 620, the data unit may be forwarded to the second network station based on the second contention window associated with the second network station based on unreserved transmission contention with other network nodes transmitting signals to the second network station (624).

As another example of operation 620, the data unit may be forwarded to the second network station based on a portion of the second contention window that is dedicated to data units that have been transmitted based on the first contention window (626). For example, the relay station RS1 420 may receive frames transmitted from relay station RS2 430 based on the contention window associated with the relay station RS 1 420. The relay station RS 1 420 may then transmit those received frames to the BS 404 using a dedicated portion, e.g., k transmission opportunities, via the contention window associated with the BS 404.

It is to be understood that the techniques discussed herein may be applied to relay in various wireless technology, and is not limited only to WiMax MMR.

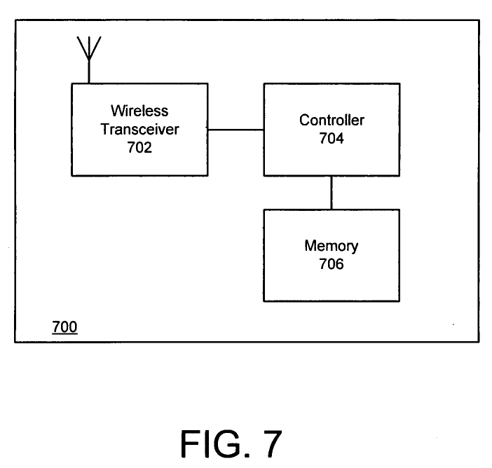

FIG. 7 is a block diagram illustrating an apparatus 700 that may be provided in a wireless node according to an example embodiment. The wireless node (e.g. station or AP) may include, for example, a wireless transceiver 702 to transmit and receive signals, a controller 704 to control operation of the station and execute instructions or software, and a memory 706 to store data and/or instructions.

Controller 704 may be programmable and capable of executing software or other instructions stored in memory or on other computer media to perform the various tasks and functions described above, such as one or more the tasks or methods described above in FIGS. 1-6. For example, the apparatus 700 may, through operation of controller 704 and other devices in apparatus 700, may receive a data unit transmitted from a network node based on a first contention window associated with a first network station, and then may forward the data unit to a second network station based on a second contention window associated with the second network station.

In addition, a storage medium may be provided that includes stored instructions, when executed by a controller or processor that may result in the controller 704, or other controller or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
receiving a data unit transmitted from a network node based on a first contention window associated with a first network station; and
forwarding the data unit to a second network station based on a second contention window associated with the second network station.

2. The method of claim 1 wherein at least one of the first and second network stations comprises a relay station.

3. The method of claim 2 wherein backoff is performed by the relay station when a collision is determined.

4. The method of claim 1 wherein backoff is performed by the network node when a collision is determined.

5. The method of claim 1 wherein the forwarding the data unit comprises forwarding the data unit to the second network station based on a second contention window associated with the second network station without performing backoff.

6. The method of claim 1 wherein:
the receiving the data unit comprises receiving the data unit transmitted from a network node based on a first contention window associated with a relay station located at a first level; and
the forwarding the data unit comprises forwarding the data unit to a base station based on the second contention window associated with the base station located at a second level.

7. The method of claim 1 wherein the forwarding the data unit comprises forwarding the data unit to the second network station based on the second contention window associated with the second network station based on unreserved transmission contention with other network nodes transmitting signals to the second network station.

8. The method of claim 7 wherein a size of the first contention window is substantially the same as a size of the second contention window.

9. The method of claim 8 wherein forwarding the data unit comprises forwarding the data unit to the second network station based on a transmission opportunity associated with the second contention window that is substantially the same as a transmission opportunity associated with the first contention window via which the data unit has been transmitted.

10. The method of claim 8 wherein forwarding the data unit comprises contending equally with other network nodes transmitting signals to the second network station.

11. The method of claim 7 wherein a size of the first contention window is different from a size of the second contention window.

12. The method of claim 11 wherein a size of the second contention window is determined by a base station based on one or more system parameters.

13. The method of claim 12 wherein the one or more system parameters include one or more of a number of users, a measurement of traffic load associated with one or more relay stations, or a history of collisions on an uplink.

14. The method of claim 11 wherein forwarding the data unit comprises forwarding the data unit to the second network station based on a transmission opportunity associated with the second contention window that is not substantially the same as a transmission opportunity associated with the first contention window via which the data unit has been transmitted.

15. The method of claim 1 wherein the forwarding the data unit comprises forwarding the data unit to the second network station based on a portion of the second contention window that is dedicated to data units that have been transmitted based on the first contention window.

16. The method of claim 15 wherein a size of the portion of the second contention window is determined by a base station based on one or more system parameters.

17. The method of claim 16 wherein the one or more system parameters includes one or more of a number of users, a measurement of traffic load associated with one or more relay stations, or a history of collisions on an uplink.

18. The method of claim 1 wherein the forwarding the data unit comprises forwarding the data unit to the second network station based on a portion of the second contention window that is dedicated to data units that have been received from the network node wherein the network node includes a relay station.

19. The method of claim 1 wherein one or more of the first and second contention windows is indicated by an information element sent via an IEEE 802.16 uplink map (UL-MAP).

20. An apparatus provided in a wireless node, the apparatus adapted to:
receive a data unit transmitted from a network node based on a first contention window associated with a first network station; and
forward the data unit to a second network station based on a second contention window associated with the second network station.

21. The apparatus of claim 20 wherein the first and second network stations comprise relay stations.

22. The apparatus of claim 20 wherein the apparatus adapted to forward comprises an apparatus adapted to forward the data unit to the second network station based on the second contention window associated with the second network station based on unreserved transmission contention with other network nodes transmitting signals to the second network station.

23. The apparatus of claim 22 wherein a size of the first contention window is substantially the same as a size of the second contention window.

24. The apparatus of claim 22 wherein a size of the first contention window is different from a size of the second contention window.

25. The apparatus of claim 20 wherein the apparatus adapted to forward includes the apparatus adapted to forward the data unit to the second network station based on a portion of the second contention window that is dedicated to transmissions that have been transmitted based on the first contention window.

26. The apparatus of claim 20, the apparatus further comprising:
a controller;
a memory coupled to the controller; and
a wireless transceiver coupled to the controller.

27. An apparatus comprising:
a base station;
one or more stations at a first level; and
one or more stations at a second level coupled to the base station, wherein the one or more of the stations at the first level are coupled to one of the
one or more stations at the second level, the one or more of the stations at the first level using a first contention window size, and
the one or more stations at the second level use a second contention window size.

28. An article comprising:
a storage medium;
said storage medium including stored thereon instructions that, when executed by a processor, result in:
receiving a data unit transmitted from a network node based on a first contention window associated with a first network station; and
forwarding the data unit to a second network station based on a second contention window associated with the second network station.
